(19) United States
(12) Patent Application Publication
(10) Pub. No.: US 2012/0317119 A1
(43) Pub. Date: Dec. 13, 2012

(54) Product Line Type Development Supporting Device

(75) Inventors: Takeshi Fukuda, Hitachi (JP); Kentaro Yoshimura, Yokohama (JP); Yoshitaka Atarashi, Hitachinaka (JP)

(73) Assignee: Hitachi, Ltd., Tokyo (JP)

(21) Appl. No.: 13/577,943

(22) PCT Filed: Feb. 10, 2010
(86) PCT No.: PCT/JP2010/000806

§ 371 Date: Aug. 9, 2012

(51) Int. Cl. G06F 17/30

(52) U.S. Cl. 707/737; 707/E17.089

(57) ABSTRACT

Product line type development is supported by analyzing inter-feature dependency relations based on the use state of feature in existing products and uses the analysis result.

Inter-feature linking means 15 analyses the inter-feature dependency relations in the existing products based on a product-feature related information database 14. A related information management unit 16 compares the analysis result of the inter-feature dependency relations to existing information stored in an inter-feature related information database 17, and outputs the result to an interface unit 18 and the inter-feature related information database. A developer can easily consult the analysis result.

### TECHNICAL FIELD

The present invention relates to a product line type development supporting device that supports product line type development for a product constituted by a plurality of components.

### BACKGROUND ART

In the early stage of product development, development is conducted for each target product or for differentiation thereof based on similar products. However, as the product encounters the maturity stage and customers' needs become diversified, the number of spin-off products increases and there is a demand for remarkable improvement in development efficiency. For this reason, the development scheme has been shifted to product line type development, aiming at improving development efficiency of such spin-off products.

The product line type development is also applied to software development. Herein, the product line type development in the software development is referred to as software product line development, and a product indicates software in which procedures and commands to operate a computer are described in a form that can be understood by the computer.

There is so-called embedded software that is embedded in equipment such as, as applicable fields of the software product line development, elevators, automobiles, mobile telephones, and construction equipment, to control a target. Control by such embedded software is advantageous in that flexible and highly accurate control in comparison to a method by a mechanical mechanism or an electronic circuit of the past can be realized and a great diversity of spin-off products can be developed by making changes in the software.

In the product line type development, generally, product development is performed such that a developer selects features required for the spin-off product. For this reason, it is necessary for the developer to select the features on the grounds of properly understanding the features at the time of development. In addition, in order to create an accurate feature model, it is necessary for the developer to extract features from existing products or to extract inter-feature dependency relation. Herein, a feature in the software product line development is a characteristic of a system visible to end users (refer to NPL 1).

For example, in order to correctly manage feature information, there is disclosed, a software component management device utilizing a technique in which every piece f product information, feature information, and product-feature relation information of an existing product is managed, and when at least one information piece in the above information is updated or changed, product information, feature information, or product-feature relation information that is related to the updated or changed information is automatically detected, and then the change is applied to the information and then a user is informed of the result (refer to PTL 1).

In addition, in order to support creation of a proper feature model, there is disclosed a technique for creating the proper feature model by using feature model information including individual pieces of feature information and feature-feature relation information indicating master-slave relations between features and tag information added to each feature (refer to PTL 2).

In addition, in order to extract proper features from an existing product, there is disclosed, as a software product line analyzer for analyzing the variability of a software product line, a technique in which change history data of a feature used in the existing product is converted into numerical values, factors of inter-product feature change information are analyzed, whereby a change portion that serves as a feature is automatically analyzed and extracted from the existing product (refer to PTL 3).

### CITATION LIST

### Patent Literature

[PTL 1] JP-A-2009-53951

[PTL 2] JP-A-2009-245177

[PTL 3] JP-A-2009-86791

### Non Patent Literature

[NPL 1] K. Pohl, G. Bockle, and F. Linden, Software Product Line Engineering, Springer-Verlag (2005) (written by Klaus Pohl, Gunter Bockle, Frank J Van Der Linden, translated by Yoshikazu Hayashi, Kentaro Yoshimura, Tsuyoshi Imazeki, Software Product Line Engineering, pp. 97 (2009))

### SUMMARY OF INVENTION

### Technical Problem

As an example, problems will be described by using software product line development that is a form of product line development.

In the software product line development, it is required for software developers to properly understand features for the purpose of enhancing reusability of software components and development efficiency of a product. Herein, proper understanding of features means understanding of details of individual features and understanding of dependency relations between the features. However, there is a problem in that proper understanding of the feature and then using the understanding in product development largely depends on experience of a skilled developer and therefore is greatly affected by personal bias.

In addition, since, in a product line having a large number of spin-off products, the number of features is already enormous, it is problematic that manually analyzing the dependency relations between the features is not easy.

In order to solve the above problems, as shown in PTL 1, a technique is disclosed in which databases of software components that have been developed are prepared so that feature information and product-feature information can be managed and consulted. However, the technique does not take the concept of managing and looking up inter-feature dependency relation information into consideration.

In addition, PTL 2 discloses a technique of creating a proper feature model by using inter-feature relation information indicating master-slave relations and a technique of creating the proper feature model by adding tag information to features. However, the techniques do not take extracting inter-feature dependence relations of which the features are in relation other than the master-slave relations into consideration. Moreover, since correctly deciding the tag information to be added to the features is generally difficult and mostly depends on know-how of a person who performs tagging, the techniques do not take extraction of inter-feature dependence relations from which personal dependency is excluded into consideration.

Furthermore, PTL 3 discloses a technique of extracting portions to serve as features through automatic analysis of a group of software components in which variability of software among products is reflected. However, the technique stays in the level of automatically extracting features in software, and does not take extraction of inter-feature dependency relation information into consideration.

In order to solve the above problems, the present invention aims to extract proper inter-feature dependency relations by performing automatic analysis for the combination of an enormous number of features with personal bias excluded, and to exclude personal bias from selection of features in product development by a developer who can easily use the inter-feature dependency relations.

### Solution to Problem

In order to solve the above problems, according to the present invention, there is provided a product line type development support device that is constituted by a product information database in which product information of a plurality of existing products is accumulated, a feature information database in which feature information used in the existing products is accumulated, a product-feature related information database in which product-feature related information obtained by linking the feature information to each product is accumulated, and an information management unit which classifies and manages the product information, the feature information, and the product-feature related information, and includes inter-feature linking means for performing analysis of dependency relations and linking between features with an input of the product-feature related information; an inter-feature related information database in which inter-feature related information obtained by linkage by the inter-feature linking means is accumulated; and a related information management unit which registers and manages the inter-feature related information.

In the product line type development support device, the product may be software in which procedures and commands to operate a computer are described in a form that can be understood by the computer.

In the product line type development support device, the feature may be a constant or a defined macro for switching operation processes of the software.

In the product line type development support device, the inter-feature linking means may find a support degree that is the proportion of products not only using a first feature but also using a second feature that is different from the first feature to all products, and use the support degree as an evaluation index for analyzing inter-feature dependency relations.

In the product line type development support device, the inter-feature linking means may find a reliability degree that is the proportion of products not only using a first feature but also using a second feature that is different from the first feature to all products using the first feature, and use the reliability degree as an evaluation index for analyzing inter-feature dependency relations.

In the product line type development support device, the inter-feature linking means may find a lift value that is a value obtained by multiplying the reliability degree obtained in claim 3 by the proportion of all products to products using a second feature for a first and the second features, and use the value as an evaluation index for analyzing inter-feature dependency relations.

In the product line type development support device, the inter-feature linking means may set threshold values for at least any one of the evaluation indices of the support degree, the reliability degree, and the lift value and compare the values, and then determines the presence of the inter-feature dependency relations.

In the product line type development support device, the related information management unit may include a new inter-feature related information checking part which is input with the inter-feature related information linked by the inter-feature linking means, compare the input information to existing inter-feature related information accumulated in the inter-feature related information database, and then check for the presence of new inter-feature related information, and an inter-feature related information management part which registers and manages the new inter-feature related information.

The product line type development support device may include an interface unit on which the inter-feature related information linked by the inter-feature linking means and at least anyone of the evaluation indices of the support degree, the reliability degree and the lift value described in claims 4 to 6 are displayed to a developer.

In the product line type development support device, when the developer develops a product based on the feature information, the inter-feature dependency relations may be automatically reflected thereon based on the inter-feature related information.

In the product line type development support device, when the developer develops a product based on the feature information, if a combination of the features is determined to be not proper based on the inter-feature related information, a warning may be given to the developer.

In the product line type development support device, the feature may be a constant or a defined macro for switching operation of software for controlling cruise control, engine control, braking control, speed control, inter-vehicle distance control, preceding vehicle recognition, laser radar, millimeter-wave radar, cameras, air bags, ABS function, key-less entry systems, traction control, light control, and seat belt control in the development of software for automobiles.

In the product line type development support device, the feature may be a constant or a defined macro for switching operation of software for controlling both side safety shoes, multi-beam door sensors, multi-beam door sensors with door signal, specification for a wheelchair-accessible elevator, specification for visually-handicapped persons, security systems, security cameras, independent automatic operation, group supervisory operation, VIP operation, automatic rescue operation, automatic stop of car illumination and ventilating fans, the function of cancelling mischievous car destination floor button registration, the function of collectively cancelling calls in reverse operations, overload detection devices, and a door open time extension button, in the development of software for elevators.

In the product line type development support device, the feature may be a constant or a defined macro for switching operation of software for controlling engine control, braking control, speed control, turning control, fluctuating slow speed control, traction control, light control, door control, hydraulic sensors, air-pressure sensors, unlimited activation control, the self-diagnosis function, the over-winding prevention function, shovel control, monitor panel control, and alarms in the development of software for construction equipment.

### Advantageous Effects of Invention

According to the present invention, by converting inter-feature dependency relations into numerical values and analyzing the relations based on feature information used for an existing product, it is possible to easily analyze, not through a manual operation but through an automatic operation, the inter-feature dependency relations even if a combination of the relations has several thousand patterns. In addition, since a developer can use inter-feature dependency relation information automatically analyzed, it is possible to automatically select features in dependency relations when the features are to be selected in product development. The developer may be advised to be cautious with such inter-feature dependency relation information when he or she uses a combination of features that cannot coexist. Accordingly, it is possible to exclude personal dependency and reduce mistakes in specification design in the stage of product development, thereby boosting development efficiency. As a result, product development cycle can be hastened.

### BRIEF DESCRIPTION OF DRAWINGS

FIG. 1 shows a configuration of a product line type development supporting device.

FIG. 2 shows product information of an existing product.

FIG. 3 shows feature information used in the existing product.

FIG. 4 shows a configuration of an information management unit.

FIG. 5 shows information of use and non-use of the existing products and features.

FIG. 6 shows a configuration of inter-feature linking means.

FIG. 7 is a flowchart showing the flow of a process of support degree computation means.

FIG. 8 shows the computation result of a support degree.

FIG. 9 is a flowchart showing the flow of a process of reliability degree computation means.

FIG. 10 shows the computation result of a reliability degree.

FIG. 11 is a flowchart showing the flow of a process of independent support degree computation means.

FIG. 12 shows the computation result of an independent support degree.

FIG. 13 is a flowchart showing the flow of a process of lift value computation means.

FIG. 14 shows the computation result of a lift value.

FIG. 15 shows a threshold value input screen.

FIG. 16 is a flowchart showing the flow of a process of dependency relation analysis means.

FIG. 17 shows the analysis result of dependency relations.

FIG. 18 shows a configuration of a related information management unit.

FIG. 19 is a flowchart showing the flow of a process of new inter-feature related information checking means.

FIG. 20 is a flowchart showing the flow of a process of an inter-feature related information management part.

FIG. 21 shows a confirmed required relation information checking screen.

FIG. 22 shows required relation checking information.

FIG. 23 shows the flow of a process of a management information classifying unit.

FIG. 24 is a flowchart showing the flow of a process of a product information management part.

FIG. 25 is a flowchart showing the flow of a process of a feature information management part.

FIG. 26 is a flowchart showing the flow of a process of a product-feature related information management part.

FIG. 27 shows feature information indicating the result of inter-feature information linking means.

FIG. 28 shows a feature tree indicating the result of the inter-feature information linking means.

FIG. 29 shows a screen for selecting product specification features.

FIG. 30 shows a state where warning is given on the screen for selecting the product specification features.

### DESCRIPTION OF EMBODIMENTS

Hereinafter, a software development supporting device according to an embodiment of the present invention will be described with reference to the drawings.

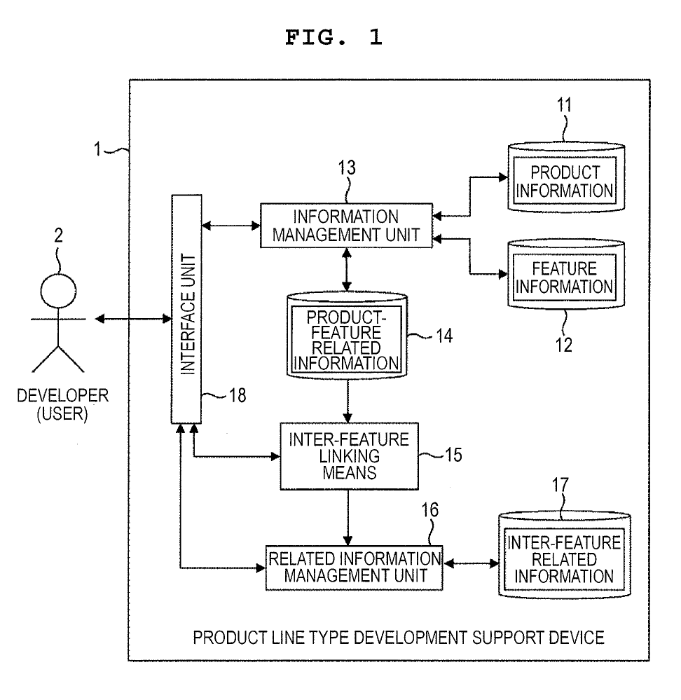

FIG. 1 is a diagram showing an overview of a system configuration example of a product line type development supporting device according to an embodiment of the present invention. As shown in FIG. 1, the product line type development supporting device according to the embodiment includes a product information database 11, a feature information database 12, an information management unit 13, a product-feature related information database 14, inter-feature linking means 15, a related information management unit 16, an inter-feature related information database 17, and an interface unit 18.

The product information database 11 is a database in which product information is accumulated. The product information includes a product ID, a model name, a product group, a product start time, a product end time, and a feature ID in use.

The feature information database 12 is a database in which features that are constants or defined macros for switching operations of software are accumulated. Feature information includes a feature ID, a feature name, a master feature, the relation with the master feature, a feature in alternative relation, a feature in dependency relation, a feature start period, and a feature end period.

The information management unit 13 classifies and manages each kind of information including the product information accumulated in the product information database 11, the feature information accumulated in the feature information database 12, and product-feature related information accumulated in the product-feature related information database 14.

The product-feature related information database 14 is a database in which the product-feature related information for linking a product and a feature is accumulated. The information for linking a product and a feature means information of a status of using each feature in each product.

The inter-feature linking means 15 is means for automatically analyzing the presence of inter-feature dependency relations based on the status of using each feature in each product by being input with the product-feature related information.

The related information management unit 16 manages inter-feature related information in which the features are linked by the inter-feature linking means 15.

The inter-feature related information database 17 is a database in which the inter-feature related information input from the related information management unit 16 is accumulated. The inter-feature related information includes required relation and alternative relation information of which the relations are established between features.

The interface unit 18 provides an interface of communication or a screen for inputting information from, for example, a developer 2. In addition, the interface unit 18 acquires input information from the developer 2 and appropriately transfers the input information to at least one of the information management unit 13, the inter-feature linking means 15, and the related information management unit 16.

By being provided with the above configuration, the inter-feature dependency relations are automatically extracted based on information of feature used in existing products. For example, when the numbers of existing products and features used therein exceed several thousands, it takes an enormous amount of time to manually analyze the inter-feature dependency relations. The software development supporting device according to the embodiment performs analysis with an index obtained by converting the inter-feature dependency relations into numerical values, and therefore, is appropriate for analyzing the inter-feature related information in the existing products.

In addition, when product line type development is performed through feature selection, by using the inter-feature dependency relations that are automatically extracted, features in a required relation are automatically selected according to the feature selection, which can assist the developer. In addition, when a combination of features that cannot coexist is used, the developer may receive a warning of the fact. In light of these points, personal dependency can be excluded in the product line type development and mistakes in designing can be reduced, whereby a development cycle can be hastened.

Hereinbelow, description of the drawings will be provided. Furthermore, the embodiment is of the application of software product line type development to elevators.

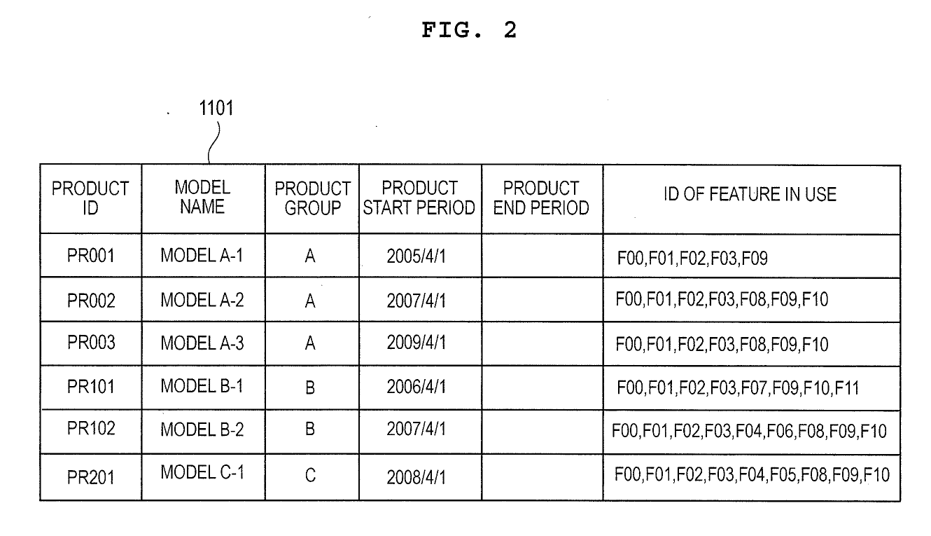

FIG. 2 is a diagram showing product information in the product information database 11. The product information includes a product ID, a model name, a product group, a product start time, a product end time, and a feature ID in use.

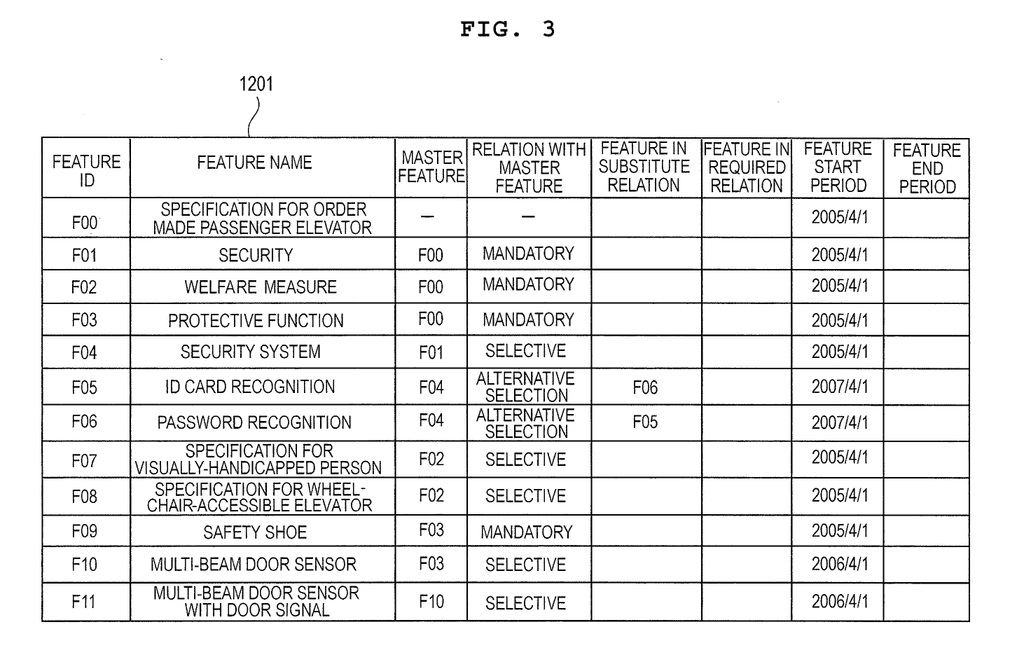

FIG. 3 shows feature information in the feature information database 12. The feature information includes a feature ID, a feature name, a master feature, the relation with the master feature, a feature in alternative relation, a feature in dependency relation, a feature start period, and a feature end period.

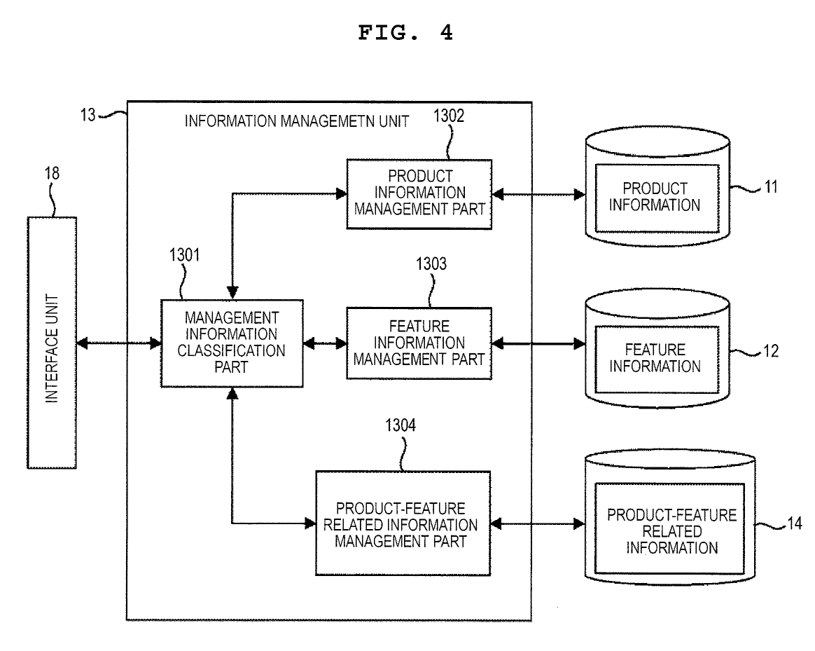

FIG. 4 concerns details of the information management unit 13. The information management unit 13 receives an input from the interface unit 18, and a management information classification part 1301 thereof classifies whether input information relates to the product information, the feature information, or the product-feature related information. In addition, if the classified information is of the product information, a product information management part 1302 performs a process, when the information is of the feature information, a feature information management part 1303 performs a process, and when the information is of the product-feature related information, a product-feature related information management part 1304 performs a process. In addition, when the management information classification part 1301 receives an input from the product information management part 1302, the feature information management part 1303, or the product-feature related information management part 1304, the resultant information is output to the interface unit 18. Accordingly, the developer 2 not only can register the product information, the feature information, and the product-feature related information through the interface unit 18, but also can easily consult the content of respective information.

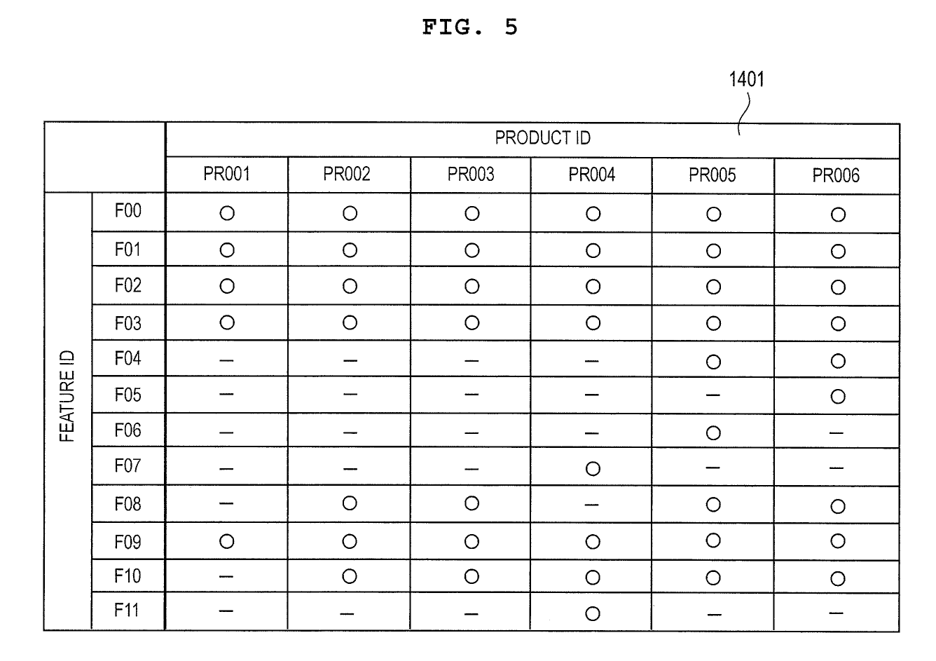

FIG. 5 is a diagram showing the product-feature related information. The product-feature related information is information of the use state of each feature in each product.

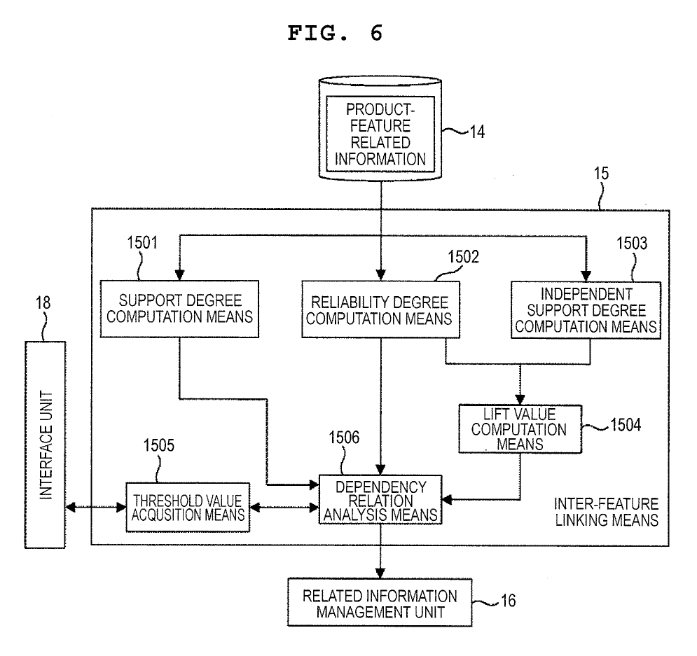

FIG. 6 shows details of the inter-feature linking means 15. The inter-feature linking means 15 analyses the inter-feature dependency relations through numerical interpretation based on the product-feature related information. Specifically, with an input of the product-feature related information database 14, support degree computation means 1501 computes a support degree, reliability degree computation means 1502 computes a reliability degree, and independent support degree computation means 1503 computes an independent support degree. In addition, with inputs of the reliability degree and the independent support degree, lift value computation means 1504 computes a lift value. In addition, threshold value acquisition means 1505 acquires threshold values of each of the lift value, the support degree, and the reliability degree from the interface unit 18. Finally, with inputs of the support degree, the reliability degree, the lift value, and the threshold values, dependency relation analysis means 1506 analyzes the inter-feature dependency relations that are the inter-feature related information, and outputs the result to the related information management unit 16.

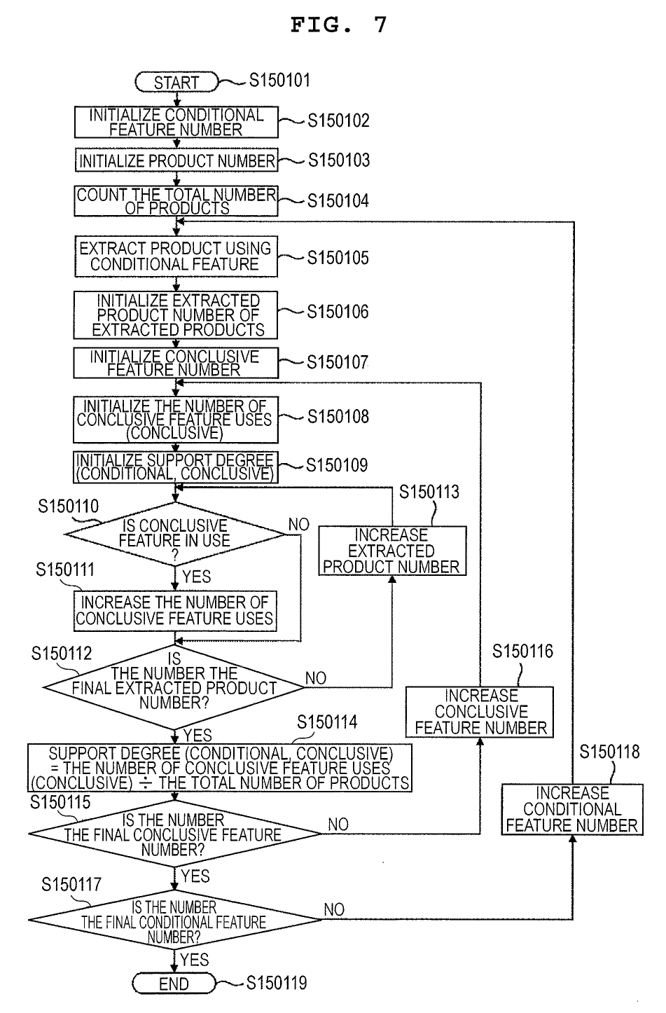

FIG. 7 is a flowchart diagram showing the detailed flow of the support degree computation means 1501. Herein, a conditional feature is a feature indicating a prerequisite, and a conclusive feature is a feature corresponding to the conclusion of the prerequisite. The process starts from Step S150101. In Step S150102, initialization of conditional feature numbers is performed. In Step S150103, initialization of product numbers is performed. In Step S150104, the total number of products is counted. In Step S150105, a product using the conditional feature is extracted from all products. In Step S150106, the product number extracted in Step S150105 is initialized. In Step S150107, conclusive feature numbers are initialized. In Step S150108, the number of conclusive feature uses is initialized. In Step S150109, the support degree is initialized. In Step S150110, it is checked whether the conclusive feature corresponding to the current conclusive feature number is used or not. When the conclusive feature is used (Yes), the process advances to Step S150111, and when it is not (No), the process advances to Step S150112. In Step S150111, 1 is added to the number of conclusive feature uses. In Step S150112, it is checked whether the product number is the final extracted product number indicating the last extracted product among the products extracted in Step S150105. When the extracted product number is the final extracted product number (Yes), the process advances to Step S150114, and when it is not (No), the process advances to Step S150113. In Step S150113, the extracted product number increases, and the process continues. In Step S150114, the support degree is computed by dividing the number of conclusive feature uses by the total number of products. In Step S150115, it is checked whether the conclusive feature number is the final conclusive feature number indicating the last conclusive feature. When the conclusive feature number is the final conclusive feature number (Yes), the process advances to Step S150117, and when it is not (No), the process advances to Step S150116. In Step S150116, the process continues by increasing the conclusive feature number. In Step S150117, it is checked whether the conditional feature number is the final conditional feature number indicating the last conditional feature number. When the conditional feature number is the final conditional feature number (Yes), the process advances to Step S150119 and then ends, and when it is not (No), the process advances to Step S150118. In Step S150118, the conditional feature number increases, and the process continues.

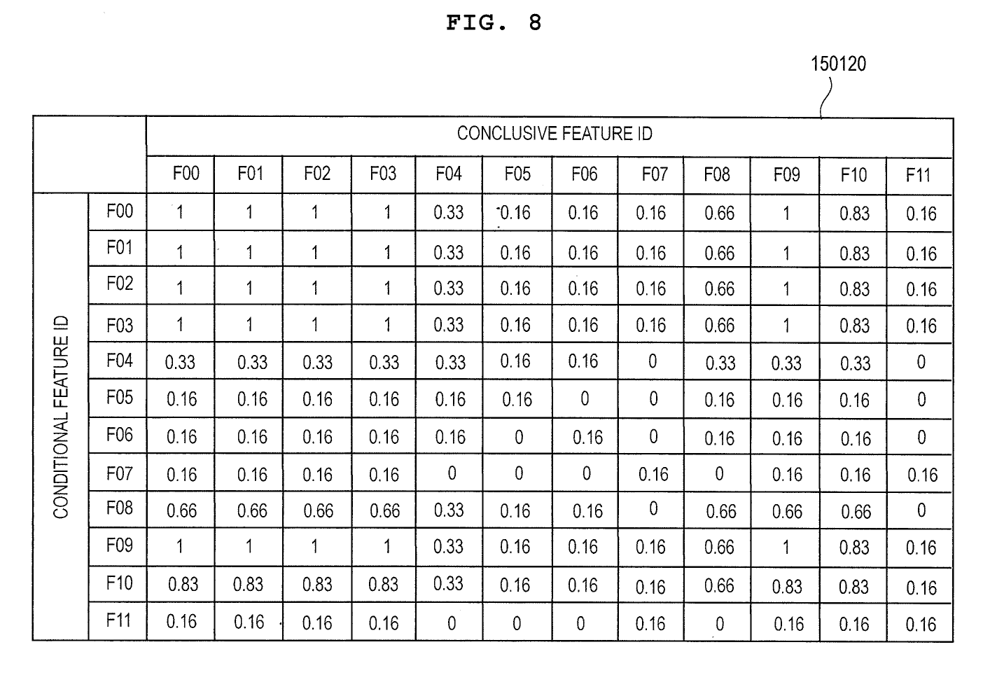

FIG. 8 is a diagram 150120 showing the support degrees computed by the support degree computation means 1501. The support degree is a value obtained by dividing the number of products having both of the conditional feature and the conclusive feature by the total number of products. The support degree indicates the proportion of products simultaneously satisfying the conditional feature and the conclusive feature in the total number of products. In other words, the higher support degree becomes, the greater is the number of products using the conditional features that serve as the prerequisites and the conclusive features that serve as the conclusion.

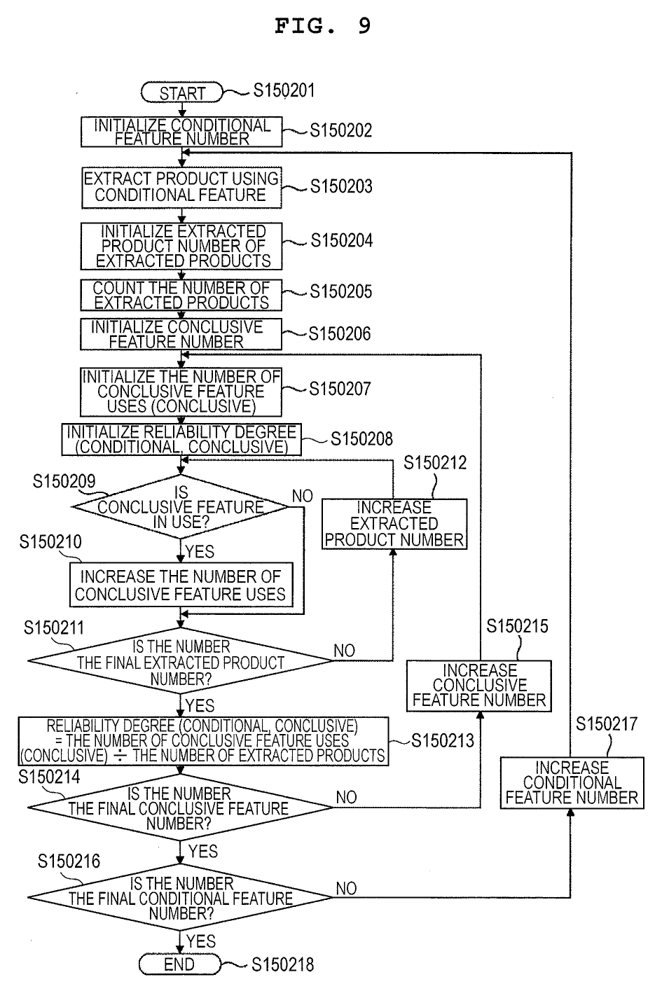

FIG. 9 is a flowchart diagram showing the detailed flow of the reliability degree computation means 1502. The process starts from Step S150201. In Step S150202, initialization of conditional feature numbers is performed. In Step S150203, products using conditional features are extracted. In Step S150204, the product numbers extracted in Step S150203 are initialized. In Step S150205, the number of extracted products is counted. In Step S150206, conclusive feature numbers are initialized. In Step S150207, the number of conclusive feature uses is initialized. In Step S150208, the reliability degree is initialized. In Step S150209, it is checked whether the conclusive feature corresponding to the current conclusive feature number is used or not. When the conclusive feature is used (Yes), the process advances to Step S150210, and when it is not (No), the process advances to Step S150211. In Step S150210, 1 is added to the number of conclusive feature uses. In Step S150211, it is checked whether the product number is the final extracted product number indicating the last extracted product among the products extracted in Step S150203. When the extracted product number is the final extracted product number (Yes), the process advances to Step S150213, and when it is not (No), the process advances to Step S150212. In Step S150212, the extracted product number increases, and the process continues. In Step S150213, the reliability degree is computed by dividing the number of conclusive feature uses by the number of extracted products. In Step S150214, it is checked whether the conclusive feature number is the final conclusive feature number indicating the last conclusive feature. When the conclusive feature number is the final conclusive feature number (Yes), the process advances to Step S150216, and when it is not (No), the process advances to Step S150215. In Step S150215, the process continues by increasing the conclusive feature number. In Step S150216, it is checked whether the conditional feature number is the final conditional feature number indicating the last conditional feature number. When the conditional feature number is the final conditional feature number (Yes), the process advances to Step S150218 and then ends, and when it is not (No), the process advances to Step S150217. In Step S150217, the conditional feature number increases, and the process continues.

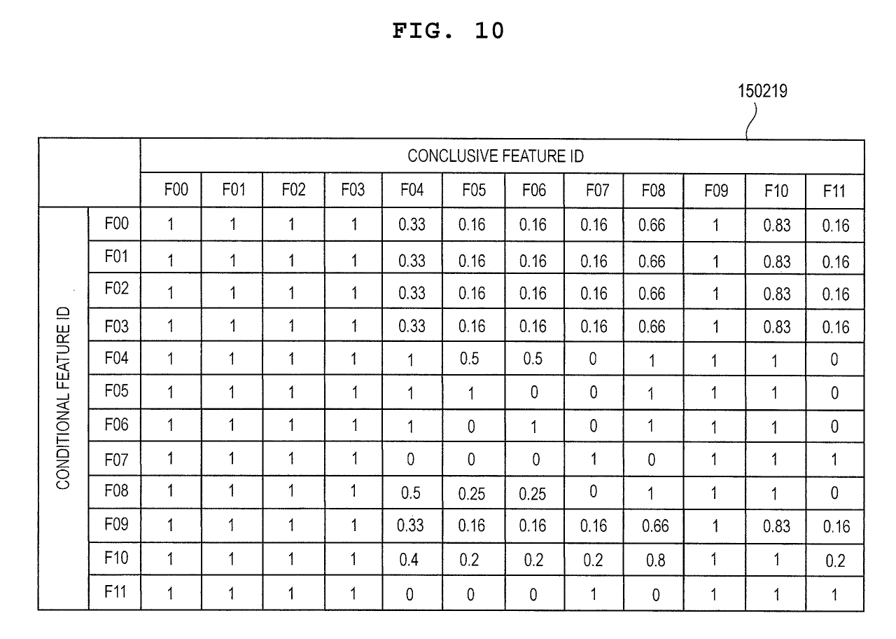

FIG. 10 is a diagram 150219 showing the reliability degrees computed by the reliability degree computation means 1502. The reliability degree is a value obtained by dividing the number of products having both of the conditional feature and the conclusive feature by the number of products having the conditional feature. The reliability degree indicates the rate of using the conclusive features when the conditional features are used. In other words, the higher reliability degree becomes, the stronger the relationship between the conditional features that serve as the prerequisites and the conclusive features that serve as the conclusion.

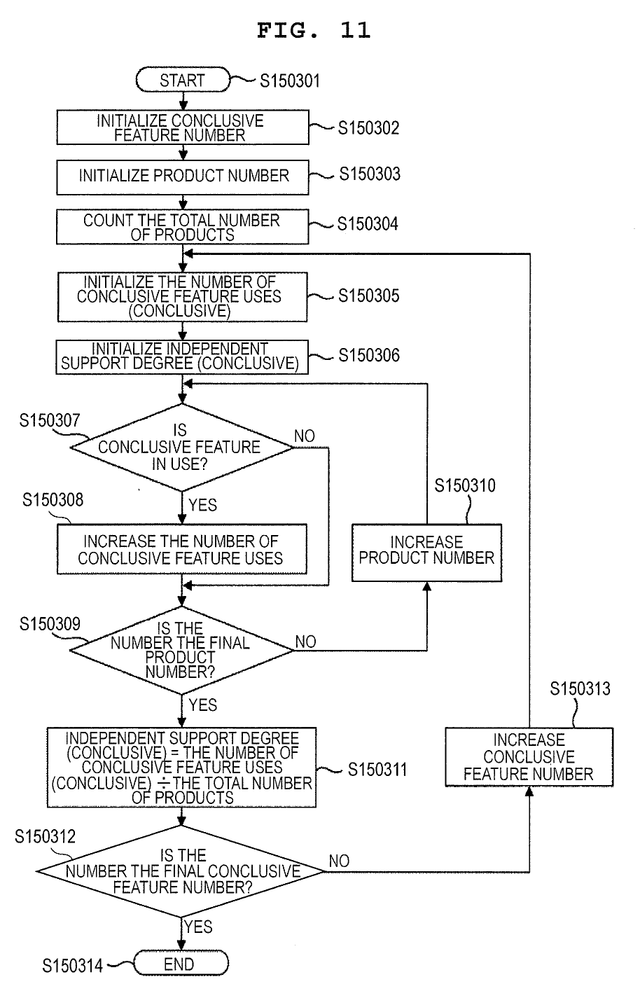

FIG. 11 is a flowchart diagram showing the detailed process of the independent support degree computation means 1503. The process starts from Step S150301. In Step S150302, initialization of conclusive feature numbers is performed. In Step S150303, initialization of product numbers is performed. In Step S150304, the total number of products is counted. In Step S150305, the number of conclusive feature uses is initialized. In Step S150306, the independent support degree is initialized. In Step S150307, it is checked whether the conclusive feature corresponding to the current conclusive feature number is used or not. When the conclusive feature is used (Yes), the process advances to Step S150308, and when it is not (No), the process advances to Step S150309. In Step S150308, 1 is added to the number of conclusive feature uses. In Step S150309, it is checked whether the product number is the final product number indicating the last product among all of the products. When the product number is the final product number (Yes), the process advances to Step S150311, and when it is not (No), the process advances to Step S150310. In Step S150310, the product number increases, and the process continues. In Step S150311, the independent support degree is computed by dividing the number of conclusive feature uses by the total number of products. In Step S150312, it is checked whether the conclusive feature number is the final conclusive feature number indicating the last conclusive feature. When the conclusive feature number is the final conclusive feature number (Yes), the process advances to Step S150314 and the process ends, and when it is not (No), the process advances to Step S150313. In Step S150313, the conclusive feature number increases and then the process continues.

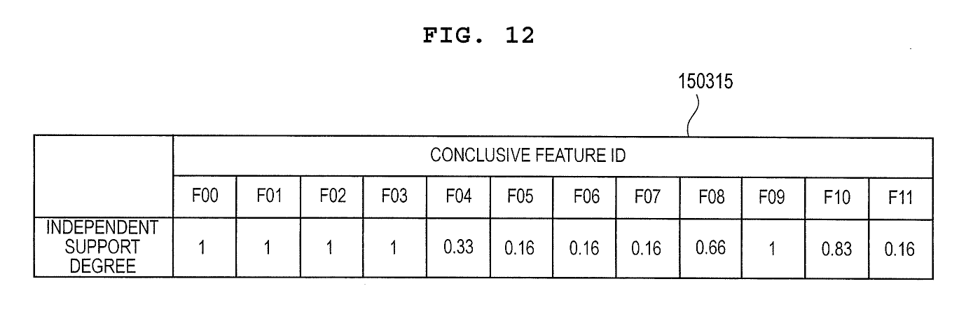

FIG. 12 is a diagram 150315 showing the independent support degrees computed by the independent support degree computation means 1503. The independent support degree is a value obtained by dividing the number of products having the conclusive feature by the total number of products. The independent support degree indicates the proportion of products using the conclusive features in the total number of products. In other words, the higher independent support degree becomes, the greater the number of products using the conclusive features is.

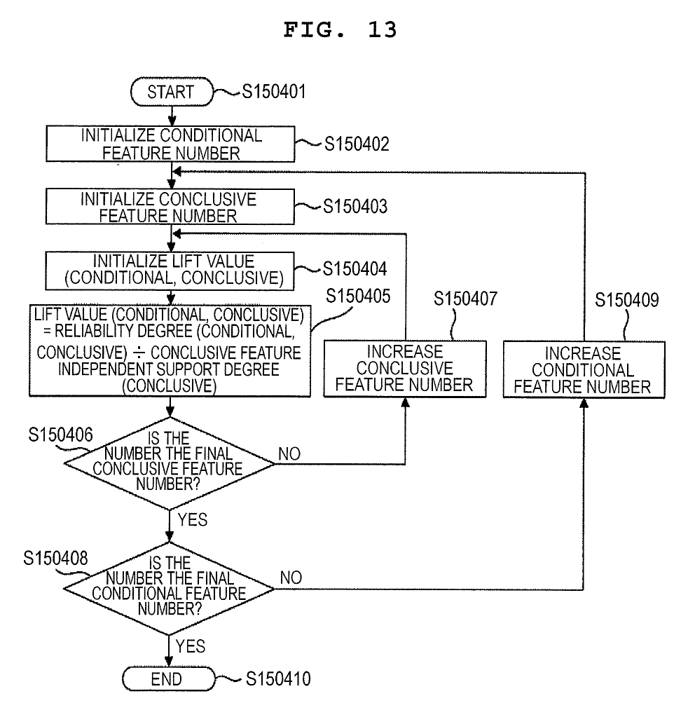

FIG. 13 is a flowchart diagram showing the detailed process of the lift value computation means 1504. The process starts from Step S150401. In Step S150402, initialization of conditional feature numbers is performed. In Step S150403, initialization of conclusive feature numbers is performed. In Step S150404, initialization of lift values is performed. In Step S150405, the lift value is computed by dividing the reliability degree computed by the inter-feature reliability degree computation means 1502 by the independent support degree computed by the inter-feature independent support degree computation means 1503. In Step S150406, it is checked whether the conclusive feature number is the final conclusive feature number indicating the last conclusive feature or not. When the conclusive feature number is the final conclusive feature number (Yes), the process advances to Step S150408, and when it is not (No), the process advances to Step S150407. In Step S150407, the conclusive feature number increases, and then the process continues. In Step S150408, it is checked whether the conditional feature number is the final conditional feature number indicating the last conditional feature number. When the conditional feature number is the final conditional feature number (Yes), the process advances to Step S150410 and the process ends, and when it is not (No), the process advances to Step S150409. In Step S150409, the conditional feature number increases, and the process continues.

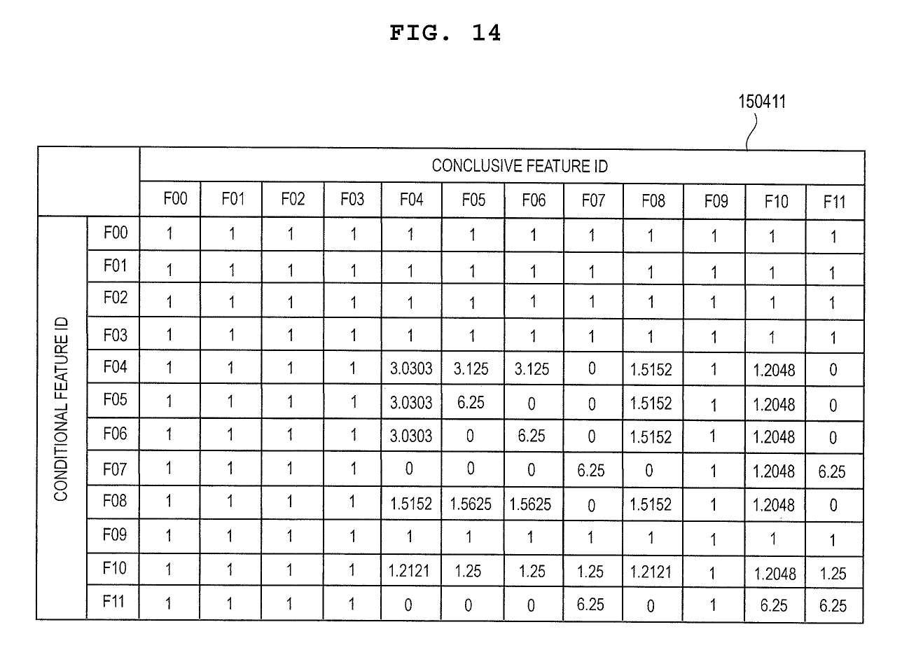

FIG. 14 a diagram 150411 showing the lift values computed by the lift value computation means 1504. The lift value is a value obtained by dividing values of the reliability degree 150219 by values of the independent support degree 150315 that is the support degree of the conclusive features of which the condition parts set to be void. The lift value indicates an index showing independency of the conditional feature and the conclusive feature. In other words, the lower the lift value is, the higher the independency of the conditional feature and the conclusive feature is, and the weaker the dependency relation is. To describe further specifically, even though the probability of the using conclusive feature in a product using the conditional features is assumed to be 95%, when the conclusive features are used in 95% of the total products, it cannot be said that the conditional feature and the conclusive features are in the dependency relation. In this case, the lift value has a low value.

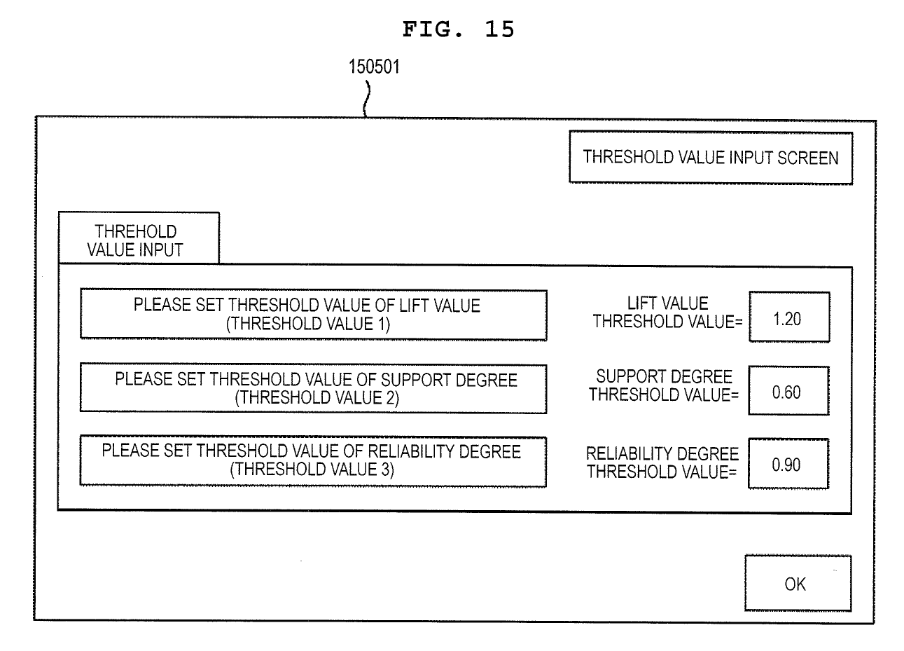

FIG. 15 is a diagram 150501 of a threshold value input screen output from the threshold value computation means 1505 to the interface unit 18. On the threshold value input screen 150501, the developer 2 inputs threshold values 1, 2, and 3 for each value of the lift value, the support degree, and the reliability degree through the interface unit 18. In this case, used values are 1.20 for the threshold value 1, 0.60 for the threshold value 2, and 0.90 for the threshold value 3.

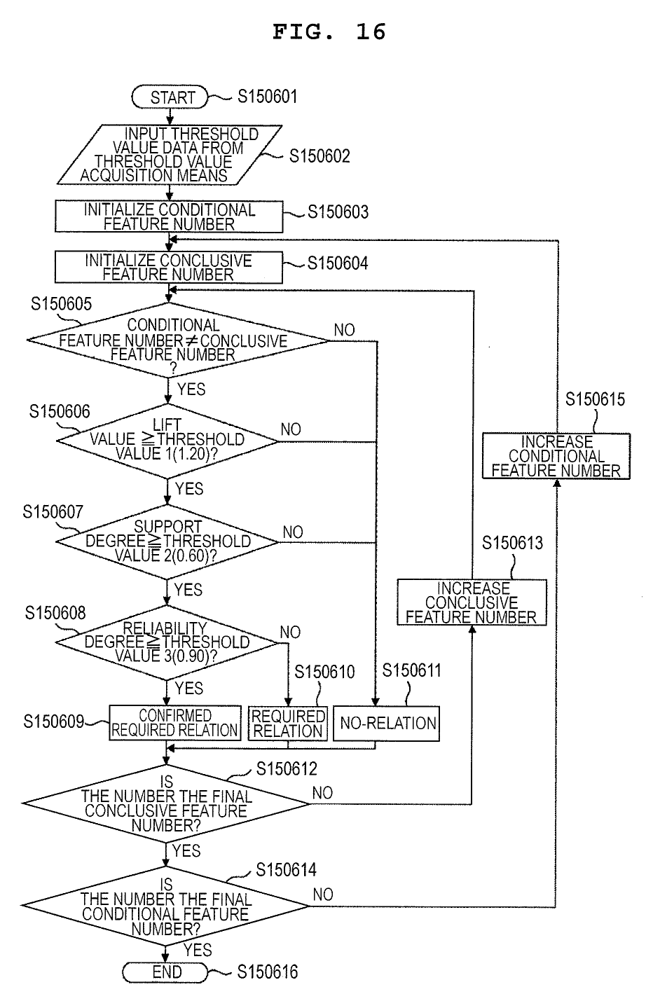

FIG. 16 is a flowchart diagram showing the detailed process of the dependency relation analysis means 1506. The process starts from Step S150601. In Step S150602, threshold value data is input from the threshold value acquisition means 1505. In Step S150603, initialization of conditional feature numbers is performed. In Step S150604, initialization of conclusive feature numbers is performed. In Step S150605, it is checked whether the conditional feature numbers are different from the conclusive feature numbers or not. When the conditional feature number is different from the conclusive feature number (Yes), the process advances to Step S150606, and when it is not (No), the process advances to Step S150611. In Step S150606, it is checked whether the lift value is greater than or equal to the threshold value 1 or not. When the lift value is greater than or equal to the threshold value 1 (Yes), the process advances to Step S150607, and when it is not (No), the process advances to Step S150611. In Step S150607, it is checked whether the support degree is greater than or equal to the threshold value 2 or not. When the support degree is greater than the threshold value 2 (Yes), the process advances to Step S150608, and when it is not (No), the process advances to Step S150611. In Step S150608, it is checked whether the reliability degree is greater than or equal to the threshold value 3 or not. When the reliability degree is greater than or equal to the threshold value 3 (Yes), the process advances to Step S150609, and when it is not (No), the process advances to Step S150610. In Step S150609, the inter-feature dependency relation is classified as confirmed required relation. In Step S150610, the inter-feature dependency relation is classified as required relation. In Step S150611, the inter-feature dependency relation is classified as no-relation. In Step S150612, it is checked whether the conclusive feature number is the final conclusive feature number indicating the last conclusive feature or not. When the conclusive feature number is the final conclusive feature number (Yes), the process advances to Step S150614, and when it is not (No), the process advances to Step S150613. In Step S150613, the conclusive feature number increases, and the process continues. In Step S150614, it is checked whether the conditional feature number is the final conditional feature number indicating the last conditional feature number or not. When the conditional feature number is the final conditional feature number (Yes), the process advances to Step S150616 and then the process ends, and when it is not (No), the process advances to Step S150615. In Step S150615, the conditional feature number increases, and the process continues.

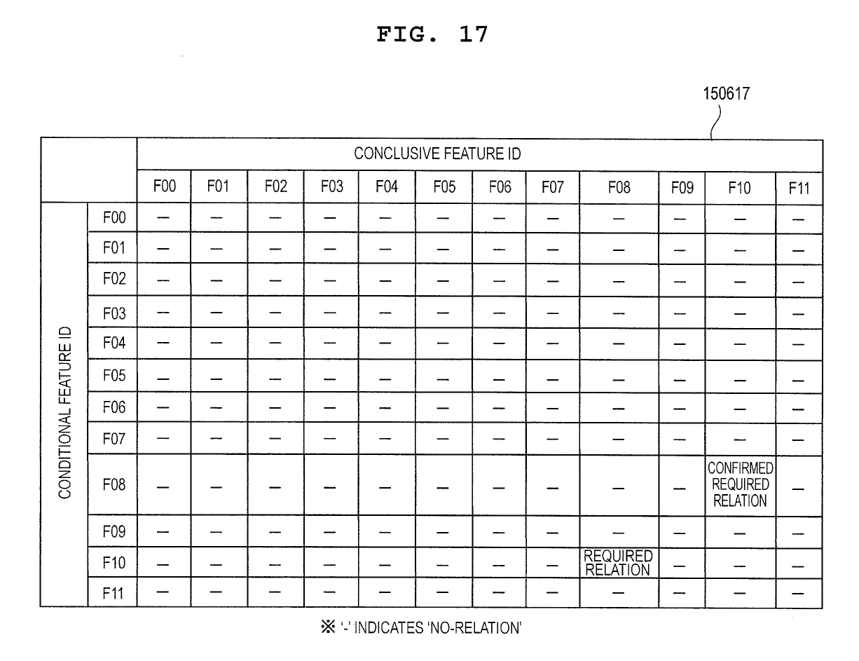

FIG. 17 is a diagram 150617 showing the inter-feature dependency relation analyzed by the dependency relation analysis means 1506. The required relation in the drawing indicates the conclusive feature required when the conditional feature is selected. In addition, whether the dependency relation is classified as the required relation or the confirmed required relation depends on the threshold value 3 set by the threshold value acquisition means 1505. The confirmed required relation has a high reliability degree and an extremely high probability of being in the dependency relation. On the other hand, the required relation has a low reliability degree and has to take being a coincidental result into consideration. In addition, “−” indicates “no-relation”.

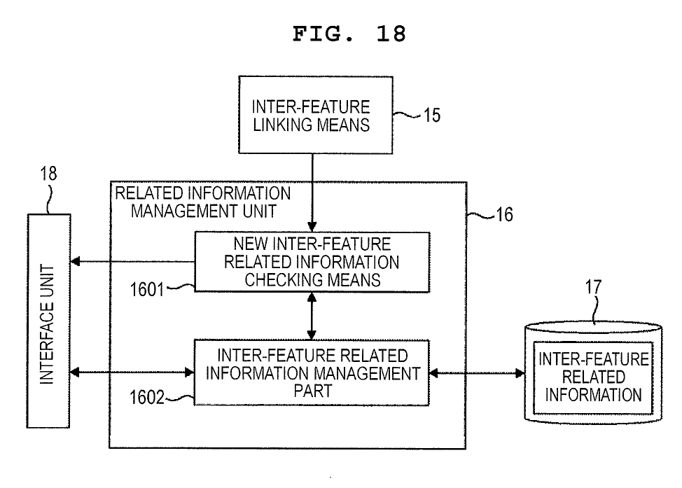

FIG. 18 concerns the details of the related information management unit 16. The related information management unit 16 receives an input from the inter-feature linking means 15 and compares, in new inter-feature related information checking means 1601, input information to data accumulated in the inter-feature related information database 17 in which the information is obtained from an inter-feature related information management part 1602. As a result of comparison, when the input information is new inter-feature related information, the information is output to the interface unit 18. On the other hand, the inter-feature related information management part 1602 receives an input from the interface unit 18 or the new inter-feature related information checking means 1601 and registers and manages the inter-feature dependency relation.

Accordingly, the developer 2 not only can check and register the new inter-feature related information through the interface unit 18, but also can easily consult the inter-feature related information.

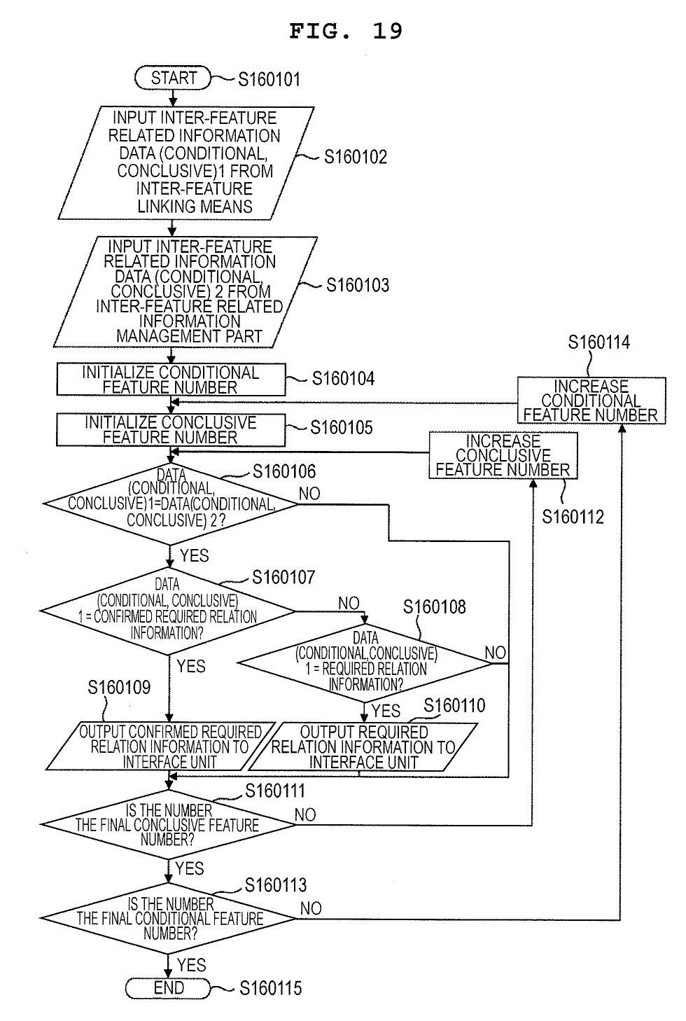

FIG. 19 is a flowchart showing the detailed process of the new inter-feature related information checking means 1601. The process starts from Step S160101. In Step S160102, inter-feature related information data 1 is input from the inter-feature linking means 15. In Step S160103, inter-feature related information data 2 is input from the inter-feature related information management part 1602. In Step S160104, conditional feature numbers are initialized. In Step S160105, conclusive feature numbers are initialized. In Step S160106, it is checked whether the data 1 is different from the data 2 or not. When the data 1 is different from the data 2 (Yes), the process advances to Step S160107, and when it is not (No), the process advances to Step S160111. In Step S160107, it is checked whether the data 1 is of the confirmed required relation or not. When the data 1 is of the confirmed required relation (Yes), the process advances to Step S160109, and when it is not (No), the process advances to Step S160108. In Step S160108, it is checked whether the data 1 is of the required relation or not. When the data 1 is of the required relation (Yes), the process advances to Step S160110, and when it is not (No), the process advances to Step S160111. In Step S160109, confirmed required relation information is output to the interface unit 18. In Step S160110, required relation information is output to the interface unit 18. In Step S160111, when the conclusive feature number is the final conclusive feature number (Yes), the process advances to Step S150613, and when it is not (No), the process advances to Step S150612. In Step S160612, the conclusive feature number increases, and the process continues. In Step S160613, it is checked whether the conditional feature number is the final conditional feature number indicating the last conditional feature number or not. When the conditional feature number is the final conditional feature number (Yes), the process advances to Step S160615 and the process ends, and when it is not (No), the process advances to Step S160614. In Step S160614, the conditional feature number increases and the process continues.

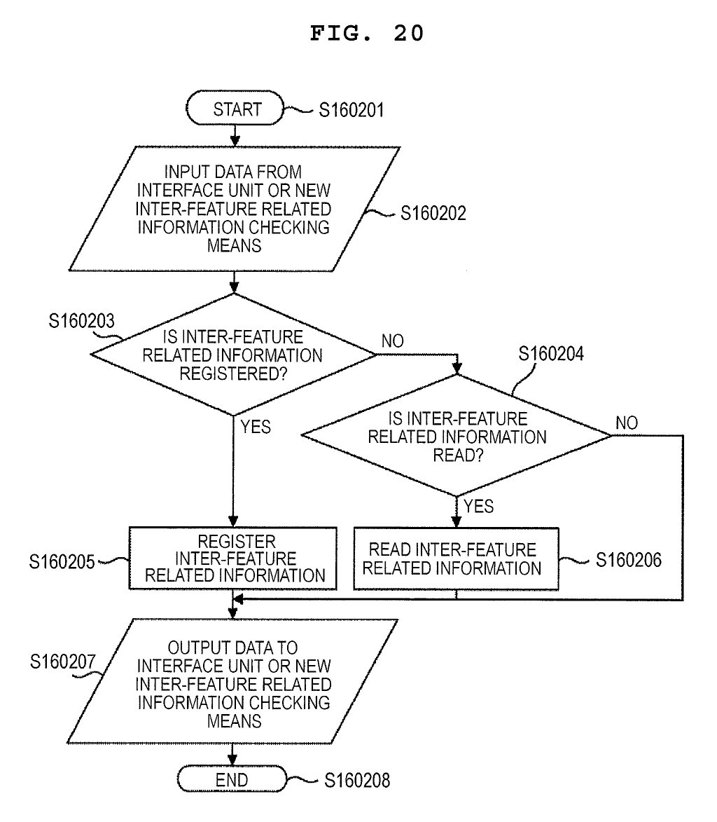

FIG. 20 is a flowchart showing the detailed process of the inter-feature related information management part 1602. The process starts from Step S160201. In Step S160201, data is input from the interface unit 18 or the new inter-feature related information checking means 160202. In Step S160203, it is checked whether the data input in Step S160202 is of inter-feature related information registration or not. When the data is of the inter-feature related information registration (Yes), the process advances to Step S160205, and when it is not (No), the process advances to Step S160204. In Step S160204, it is checked whether the data input in Step S160202 is of inter-feature related information reading or not. When the data is of the inter-feature related information reading (Yes), the process advances to Step S160206, and when it is not (No), the process advances to Step S160207. In Step S160205, registration of the inter-feature related information is performed. In Step S160206, reading of the inter-feature related information is performed. In Step 5160207, data is output to the interface unit 18 or the new inter-feature related information checking means 1601. In Step S160208, the process ends.

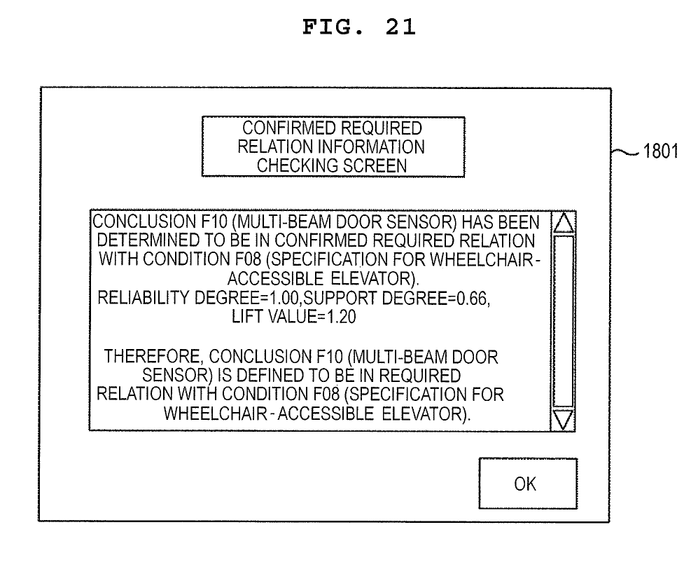

FIG. 21 shows a confirmed required relation information checking screen 1801 on the interface unit 18. As such, it is possible to automatically extract the inter-feature dependency relations by statistically analyzing the relation between a product and a feature in an existing product.

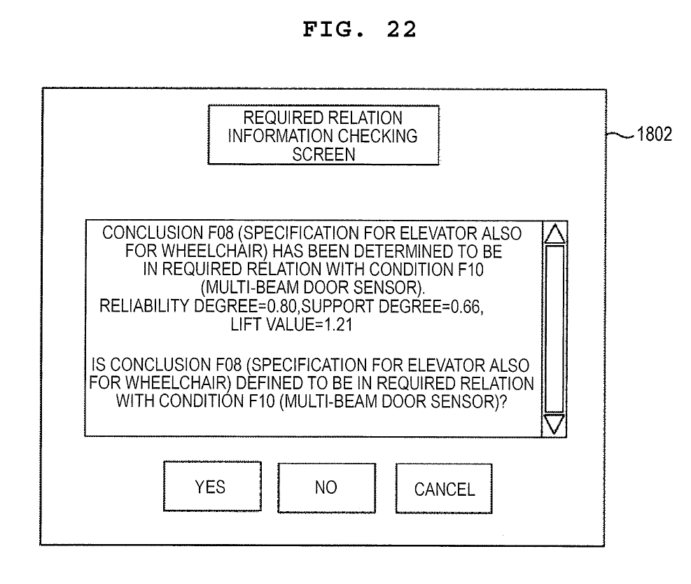

FIG. 22 shows a confirmed required relation information checking screen 1802 on the interface unit 18.

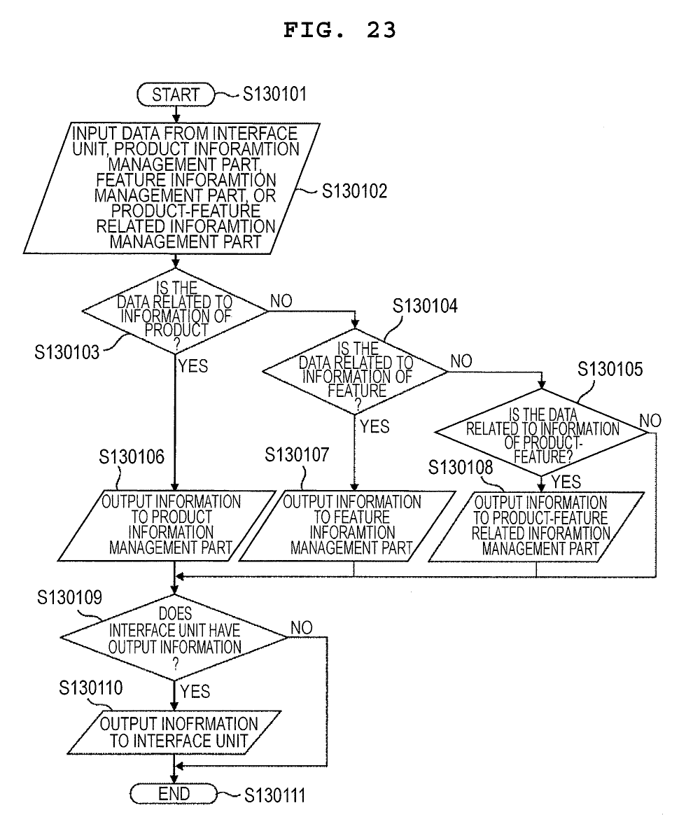

FIG. 23 is a flowchart showing the detailed process of the management information classification part 1301. The process starts from Step S130101. In Step S130102, data is input from the interface unit 18, the product information management part 1302, the feature information management part 1303, or the product-feature information management part 1304. In Step S130103, it is checked whether the data input in Step S130102 is the product information or not. When the data is the product information (Yes), the process advances to Step S130106, and when it is not (No), the process advances to Step S130104. In Step S130104 , it is checked whether the data input in Step S130102 is the feature information or not. When the data is the feature information (Yes), the process advances to Step S130107, and when it is not (No), the process advances to Step S130105. In Step S130105, it is checked whether the data input in Step S130102 is product-feature information or not. When the data is the product-feature information (Yes), the process advances to Step S130108, and when it is not (No), the process advances to Step S130109. In Step S130106, the data input in Step S130102 is output to the product information management part 1302. In Step S130107, the data input in Step S130102 is output to the feature information management part 1303. In Step S130108, the data input in Step S130102 is output to the product-feature information management part 1304. In Step S130109, it is checked whether the data input in Step S130102 includes information to be output to the interface unit 18 or not. When the data includes information to be output to the interface unit 18 (Yes), the process advances to Step S130110, and when it does not (No), the process advances to Step S130111, and then ends. In Step S130110, the data input in Step S130102 is output to the interface unit 18.

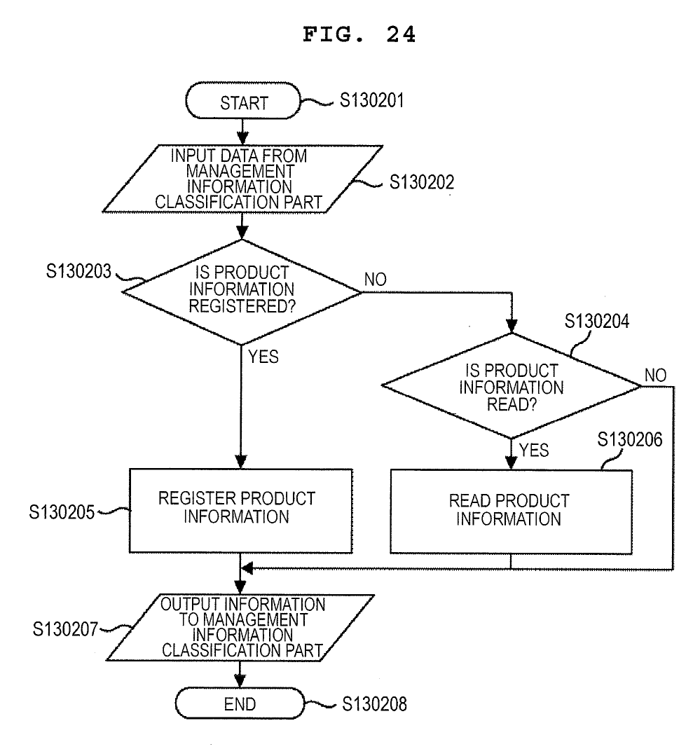

FIG. 24 is a flowchart showing the detailed process of the product information management part 1302. The process starts from Step S130201. In Step S130202, data is input from the, management information classification part 1301. In Step S130203, it is checked whether the data input in Step S130202 is of product information registration or not. When the data is of the product information registration (Yes), the process advances to Step S130205, and when it is not (No), the process advances to Step S130204. In Step S130204, it is checked whether the data input in Step S130202 is of product information reading or not. When the data is of the product information reading (Yes), the process advances to Step S130206, and when it is not (No), the process advances to Step S130207. In Step S130205, the product information input in Step S130202 is registered in the product information database 11. In Step S130206, the data in the product information database 11 is read. In Step S130207, the result of Step S130205 or Step S130206 is output to the management information classification part. In Step S130208, the process ends.

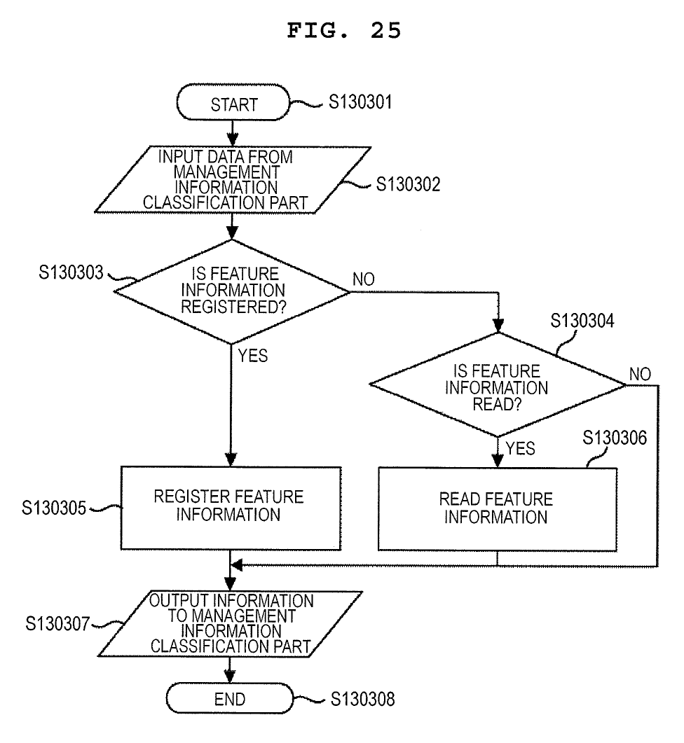

FIG. 25 is a flowchart showing the detailed process of the feature information management part 1303. The process starts from Step S130301. In Step S130302, data is input from the management information classification part 1301. In Step S130303, it is checked whether the data input in Step S130302 is of feature information registration or not. When the data is of the feature information registration (Yes), the process advances to Step S130305, and when it is not (No), the process advances to Step S130304. In Step S130304, it is checked whether the data input in Step S130302 is of feature information reading or not. When the data is of the feature information reading (Yes), the process advances to Step S130306, and when it is not (No), the process advances to Step S130307. In Step S130305, the feature information input in Step S130302 is registered in the feature information database 12. In Step S130306, the data in the feature information database 12 is read. In Step S130307, the result of Step S130305 or Step 5130306 is output to the management information classification part. In Step S130308, the process ends.

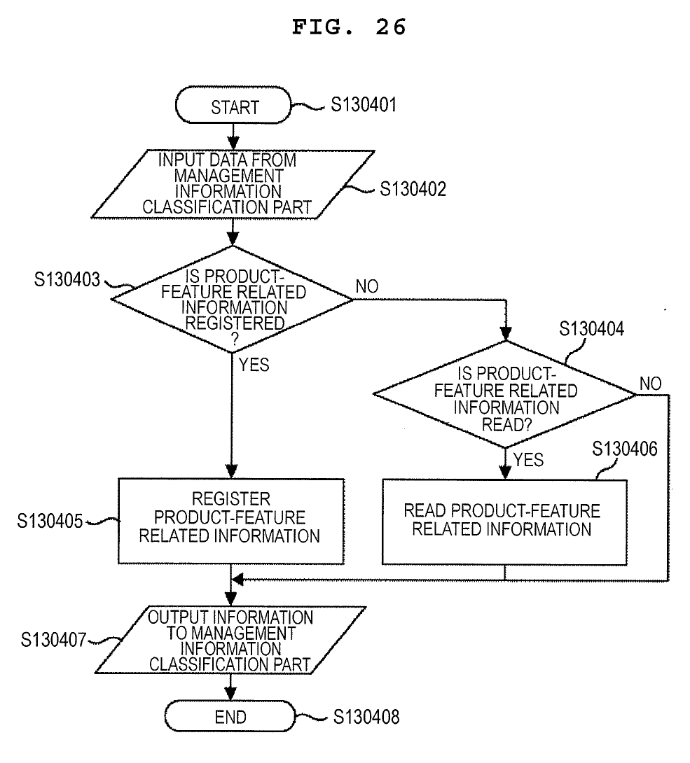

FIG. 26 is a flowchart showing the detailed process of the product-feature related information management part 1304. The process starts from Step S130401. In Step S130402, data is input from the management information classification part 1301. In Step S130403, it is checked whether the data input in Step S130402 is of product-feature related information registration or not. When the data is of the product-feature related information registration (Yes), the process advances to Step S130405, and when it is not (No), the process advances to Step S130404. In Step S130404, it is checked whether the data input in Step S130402 is of product-feature related information reading or not. When the data is of the product-feature related information reading (Yes), the process advances to Step S130406, and when it is not (No), the process advances to Step S130407. In Step S130405, the product-feature related information input in Step S130402 is registered in the product-feature related information database 14. In Step S130406, the data in the product-feature related information database 14 is read. In Step S130407, the result of Step S130405 or Step S130406 is output to the management information classification part. In Step S130408, the process ends.

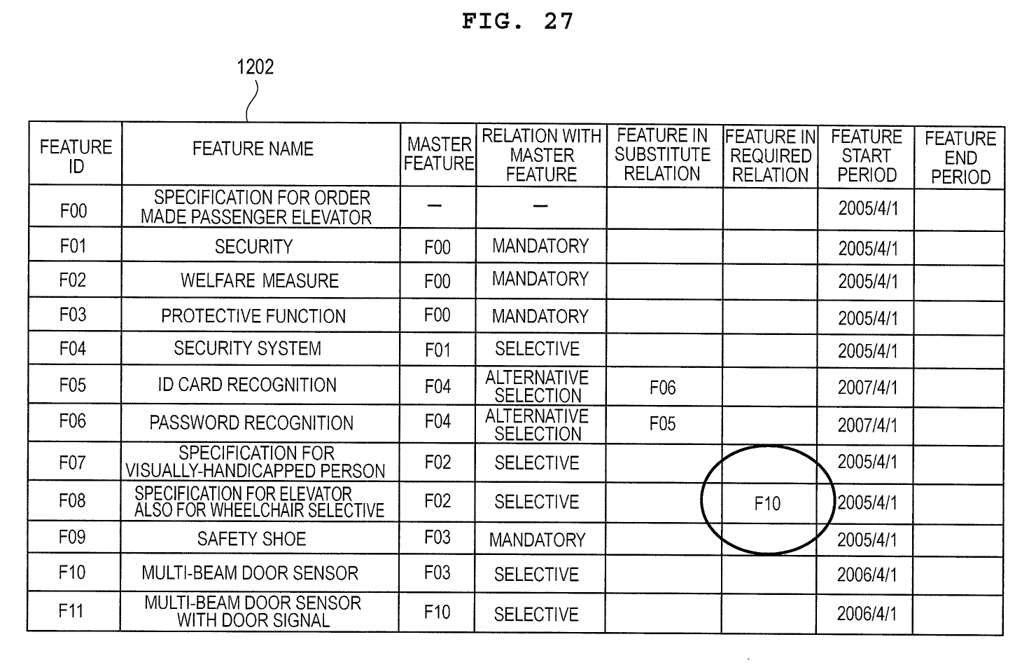

FIG. 27 is a drawing 1202 showing the feature information in the feature information database 12. As understood from comparison with the drawing 1201 showing the feature information, when F08 specification for a wheelchair-accessible elevator is used, requirement of F10 multi-beam door sensor is added as new information. As such, by statistically analyzing the use state of a feature in an existing product, the inter-feature dependency relations can be extracted.

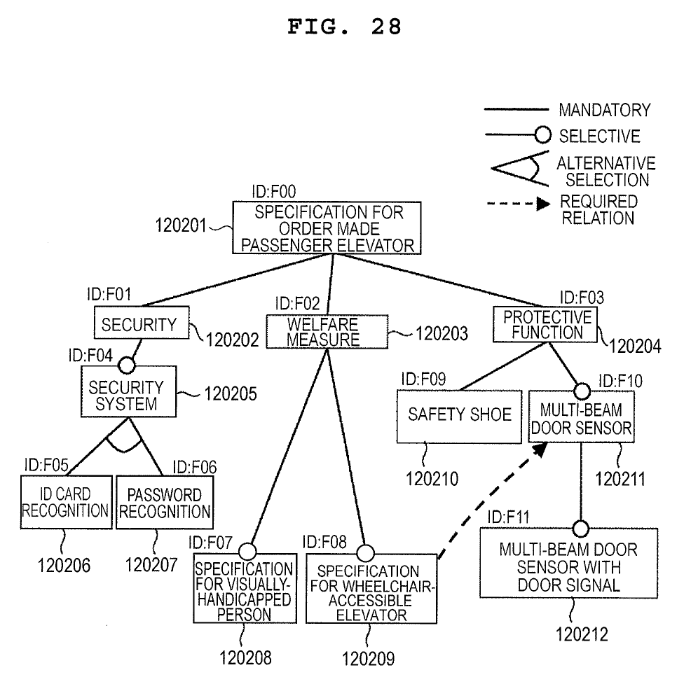

FIG. 28 is a diagram showing an example of a feature model of elevators. A dashed-line arrow is a dependency relation extracted through automatic analysis this time. Up until the existing technologies, extraction of the dependency relations has been performed only in master-slave relations in a hierarchy, however, in the present technology, it is also possible to extract the dependency relations of features having different hierarchies and lines, as shown in FIG. 28.

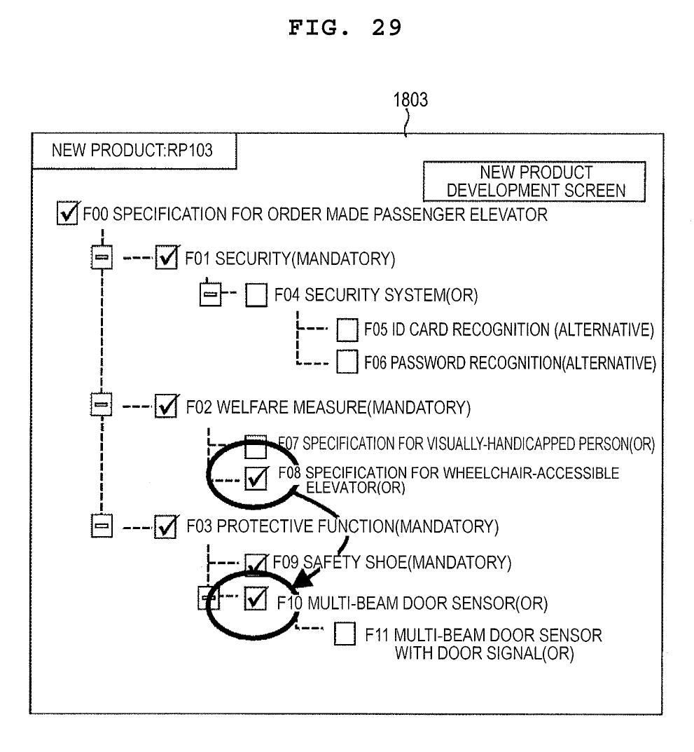

FIG. 29 shows a new product development screen by feature selection. The developer 2 develops a product satisfying requirements by selecting features. In the related art, there were such feature selection mistakes as overlooking necessary features during feature selection or as selecting features that cannot coexist. However, if the dependency relations extracted from a previous product are used as in this technique, it is possible to automatically select features required from the selected features. The drawing shows a screen in which, if F08 specification for a wheelchair-accessible elevator is selected, F10 multi-beam door sensor is automatically selected.

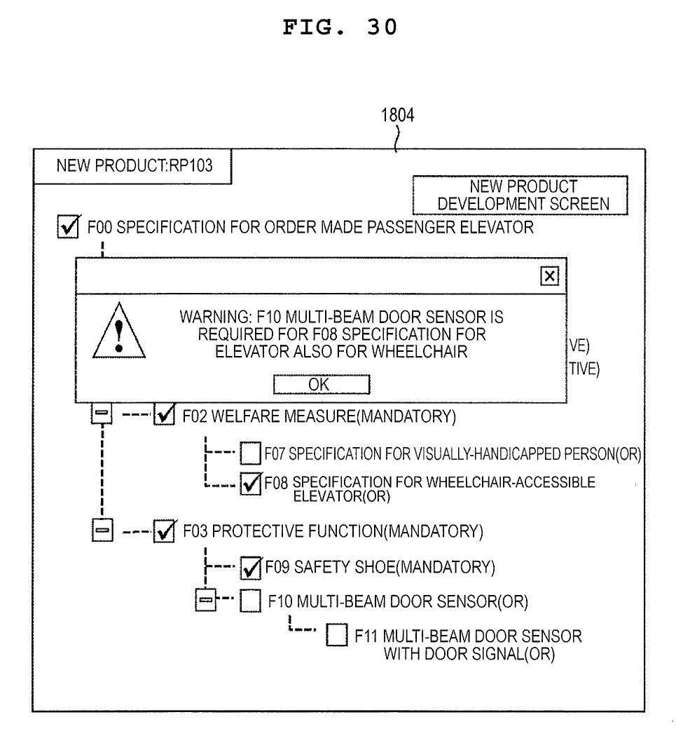

FIG. 30 is a drawing showing an example where warning is displayed on the new product development screen by feature selection. The screen shows a warning given due to the fact that a checkbox of F10 multi-beam door sensor is missed, regardless of selecting F08 specification for a wheelchair-accessible elevator. As such, when features are selected not following the inter-feature dependency relation, a warning is given so that mistakes in selecting features can be reduced.

Feature selection in the related art largely relied on experience of a skilled person, however, if the present technology is used, the inter-feature dependency relations are supportively used in feature selection, whereby personal dependency can be excluded. As such, if the present technology is used, mistakes in specification design can be reduced, whereby development efficiency can be enhanced.

Furthermore, the present invention is as effective for automobiles and construction equipment as it is for the elevators, and the description using the application example of the present invention to the elevators does not limit the claims to the elevators.

### INDUSTRIAL APPLICABILITY

The present invention can be applied to product line type development for a plurality of existing products.

### REFERENCE SIGNS LIST

1 product line type development support device
2 developer
11 product information database
12 feature information database
13 information management unit
14 product-feature related information database
15 inter-feature linking means
16 related information management unit
17 inter-feature related information database

1. A product line type development support device constituted by a product information database in which product information of a plurality of existing products is accumulated, a feature information database in which feature information used in the existing products is accumulated, a product-feature related information database in which product-feature related information obtained by linking the feature information to each product is accumulated, and an information management unit which classifies and manages the product information, the feature information, and the product-feature related information, the device comprising:
inter-feature linking means for performing analysis of dependency relations and linking between features with an input of the product-feature related information;
an inter-feature related information database in which inter-feature related information obtained by linkage by the inter-feature linking means is accumulated; and
a related information management unit which registers and manages the inter-feature related information.

2. The product line type development support device according to claim 1, wherein the product is software in which procedures and commands to operate a computer are described in a form that can be understood by the computer.

3. The product line type development support device according to claim 2, wherein the feature is a constant or a defined macro for switching operations of the software.

4. The product line type development support device according to claim 1, wherein the inter-feature linking means finds a support degree that is the proportion of products not only using a first feature but also using a second feature that is different from the first feature to all products, and uses the support degree as an evaluation index for analyzing inter-feature dependency relations.

5. The product line type development support device according to claim 1, wherein the inter-feature linking means finds a reliability degree that is the proportion of products not only using a first feature but also using a second feature that is different from the first feature to all products using the first feature, and uses the reliability degree as an evaluation index for analyzing inter-feature dependency relations.

6. The product line type development support device according to claim 5, wherein the inter-feature linking means finds a lift value that is a value obtained by multiplying the reliability degree by the proportion of all products to products using a second feature for first and second features, and uses the value as an evaluation index for analyzing inter-feature dependency relations.

7. The product line type development support device according to claim 4, wherein the inter-feature linking means sets threshold values for at least any one of evaluation indices of the support degree, a reliability degree, and a lift value and compares the values, and then determines the presence of the inter-feature dependency relations.

8. The product line type development support device according to claim 4, wherein the related information management unit includes a new inter-feature related information checking part which is input with the inter-feature related information linked by the inter-feature linking means, compares the input information to existing inter-feature related information accumulated in the inter-feature related information database, and then checks the presence of new inter-feature related information, and an inter-feature related information management part which registers and manages the new inter-feature related information.

9. The product line type development support device according to claim 4, comprising:
an interface unit on which the inter-feature related information linked by the inter-feature linking means and at least anyone of the evaluation indices of the support degree, a reliability degree and a lift value displayed to a developer.

10. The product line type development support device according to claim 1, wherein, when a developer develops a product based on the feature information, the inter-feature dependency relations are automatically reflected thereon based on the inter-feature related information.

11. The product line type development support device according to claim 1, wherein, when a developer develops a product based on the feature information, if a combination of features is determined to be not proper based on the inter-feature related information, a warning is given to the developer.

12. The product line type development support device according to claim 1, wherein the feature is a constant or a defined macro for switching operation of software for controlling cruise control, engine control, braking control, speed control, inter-vehicle distance control, preceding vehicle recognition, laser radar, millimeter-wave radar, cameras, air bags, ABS function, a key-less entry system, traction control, light control, and seat belt control in the development of software for automobiles.

13. The product line type development support device according to claim 1, wherein the feature is a constant or a defined macro for switching operation of software for controlling both side safety shoes, multi-beam door sensors, multi-beam door sensors with door signal, specification for a wheelchair-accessible elevator, specification for visually-handicapped persons, security systems, security cameras, independent automatic operation, group supervisory operation, VIP operation, automatic rescue operation, automatic stop of car illumination and ventilating fans, the function of cancelling mischievous car destination floor button registration, the function of collectively cancelling calls in reverse operations, overload detection devices, and a door open time extension button, in the development of software for elevators.

14. The product line type development support device according to claim 1, wherein the feature is a constant or a defined macro for switching operation of software for controlling engine control, braking control, speed. control, turning control, fluctuating slow speed control, traction control, light control, door control, hydraulic sensors, air-pressure sensors, unlimited activation control, the self-diagnosis function, the over-winding prevention function, shovel control, monitor panel control, and alarms in the development of software for construction equipment.
